(19) United States
(12) Patent Application Publication
(10) Pub. No.: US 2011/0051229 A1
(43) Pub. Date: Mar. 3, 2011

(54) ACHROMATIC VISIBLE TO FAR INFRARED OBJECTIVE LENS

(75) Inventor: Christopher Alexay, Keene, NH (US)

(73) Assignee: StingRay Optics, LLC, Keene, NH (US)

(21) Appl. No.: 12/862,906

(22) Filed: Aug. 25, 2010

Related U.S. Application Data
(60) Provisional application No. 61/275,134, filed on Aug. 25, 2009.
(60) Provisional application No. 61/316,375, filed on Mar. 22, 2010.

(51) Int. Cl. G02B 13/14

(52) U.S. Cl. 359/356

(57) ABSTRACT

Disclosed herein are lens systems that are capable of imaging in the visible spectrum to the far infrared spectrum. The lens systems are formed from optical crystals with different and substantially parallel partial dispersion characteristics.

### RELATED CASES

Priority is hereby claimed to U.S. Provisional Patent Application Nos. 61/275,134, filed on Aug. 25, 2009, and 61/316,375, filed on Mar. 20, 2010, both of which are incorporated herein by reference in their entirety.

### TECHNICAL FIELD

The present disclosure is directed to a wide band achromatic objective lens that provides high quality imaging in the visible spectrum to the far infrared spectrum, or portions thereof.

### BACKGROUND

Applications for optical glasses may require very specific refractivity and dispersion properties, and extremely high quality and uniformity may be needed to meet the particular application requirements. The composition of optical glasses determines, at least in part, their refractivity and dispersion properties. For example, lead oxide is a major ingredient of flint glass, imparting a high refractive index and dispersion, as well as surface brilliance. The refractivity and dispersion properties of optical glasses can be adjusted by adding materials to the glasses. Consequently, many types of optical glasses have been developed to meet the needs of industry. However, of the many types of glasses that have been developed for imaging, none are capable of transmitting energy over very large spectral ranges.

The present disclosure provides compact lens systems with superior performance in wavelengths ranging from the visible to the far infrared spectral region.

### SUMMARY

The present disclosure is directed, in one embodiment, to lens system comprising a first, positive lens comprising a first optical crystal material and a second, negative lens adjacent to the first lens. The second lens comprises a second optical crystal material, different than the first optical crystal material. The lens system is operative for imaging in a spectral region with wavelengths ranging from about 0.5 microns (μm) to about 12.0 μm.

Another embodiment is directed to a lens system comprising a first, positive lens comprising a first optical crystal material; a second, negative lens adjacent to the first lens, the second lens comprising a second optical crystal material, different than the first optical crystal material; and a third lens adjacent to the second lens, opposite the first lens, the third lens being selected from the group consisting of potassium bromide, zinc sulfide and zinc selenide. The lens system is operative for imaging in a spectral region with wavelengths ranging from about 0.5 microns (μm) to about 12.0 μm.

Another embodiment is directed to a lens system comprising a first lens comprising potassium bromide, and a second lens adjacent to the first lens, the second lens comprising zinc sulfide. The lens system is operative for imaging in a spectral region with wavelengths ranging from about 0.5 microns (μm) to about 12.0 μm.

### BRIEF DESCRIPTION OF THE DRAWINGS

The foregoing and other features and advantages will be apparent from the following more particular description of exemplary embodiments of the disclosure, as illustrated in the accompanying drawings, in which like reference characters refer to the same parts throughout the different views. The drawings are not necessarily to scale, emphasis instead being placed upon illustrating the principles of the disclosure.

FIG. 1 is a graphical representation of the relative dispersion of various materials as a function of wavelength;

FIG. 2 is a graphical representation of the relative partial dispersion of several optical materials as a function of wavelength;

FIG. 3 is a schematic side view of an exemplary doublet lens system according to the present disclosure;

FIG. 4 is a graphical representation of wavelength of the doublet lens system of FIG. 3 as a function of spot radius;

FIG. 5 is a side view of an exemplary triplet lens system according to the present disclosure;

FIG. 6 is a side view of another exemplary triplet lens system according to the present disclosure;

FIG. 7 is a side view of an exemplary catadioptric lens system according to the present disclosure; and

FIG. 8 is a side view of another exemplary catadioptric lens system with a simultaneous dual waveband and dual field of view lens.

### DETAILED DESCRIPTION

The present disclosure is directed to achromatic objective lens systems suitable for high quality imaging in a wide spectral band i.e., in the spectral range extending from the visible to the far infrared (“VIS-IR”) wavelength regions, or portions thereof. The term VIS-IR region, as used herein, means the spectral region with wavelengths ranging from about 0.5 microns (“μm”) to about 12.0 μm. The present lens systems are color corrected and have very low levels of secondary and higher order spectra throughout the VIS-IR region.

The resulting lens systems have substantially low levels of chromatic aberration, which allows imaging over very broad ranges with one lens, thereby reducing the size needed to house a multi-spectral imaging platform.

One method for identifying suitable achromatic parings of optical materials is to select materials which have large dispersive differences, and small differences in their relative partial dispersion. The following Equations 1 and 2 can be used to find suitable achromatic pairings:

Optical dispersion: V=(n_{med}−1)/(n_{low}−n_{high}) (1)

Relative partial dispersion: P=(n_{low}−n_{med})/(n_{low}−n_{high}) (2)

where n_{low}, n_{med}, n_{high} represent the refractive index of a material at the lowest, median and highest wavelength in the waveband of an optical design respectively. The accuracy of the foregoing equations is inversely proportional to the size of the spectral band over which they are used, because the dispersive behavior of most optical materials is non-linear, resulting in a loss of accuracy over larger spectral regions. Therefore, if it is desired to identify two materials with superior performance over a spectral range extending from the visible to the far infrared, the foregoing equations do not provide sufficient information regarding the behavior of materials in such an optical design.

The present optical materials are selected using a different method, which is described in greater detail below. Lens systems according to the present disclosure are made using optical materials that have aspects of both dispersion and transmission. The design of the lens systems is based on an analysis of the relative change in dispersion and partial dispersion of materials over entire spectral range of interest i.e., the VIS-IR region. The materials are selected based on the behavior of their partial dispersion as it changes with wavelength. That is, suitable materials for the present lens systems are those for which the difference in the partial dispersion values is as small as possible over the VIS-IR region; that is, the partial dispersions are near in value. Deviations from such trending may result in performance degradation at the points where the difference in the partial dispersion values increase.

According to the present disclosure, the lens materials are selected using a method developed by Newton for analyzing the instantaneous slope of a function via iteration. It is known from the definition of the derivative at a given point that it is the slope of a tangent at that point, which enables the study of the instantaneous values of the optical dispersion for any material, despite the non-linear behavior of the material. The following Equation 3 illustrates not only the dispersive property of a material, but also how the non-linear dispersive characteristics can impact the pairing of candidate materials:

$${δ}^{′} ( {λ}_{n} ) := \frac{Δ n}{Δ λ} \qquad ( 3 )$$

where n represents the refractive index of a material at a wavelength of 2.

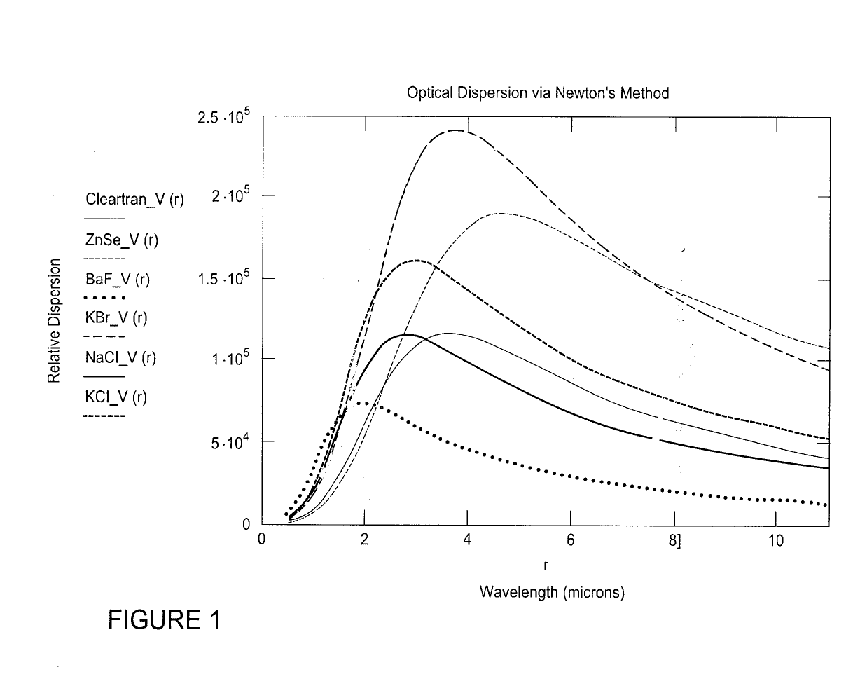

FIG. 1 shows the dispersive behavior of several different optical crystal materials that exhibit suitable dispersive behavior for transmissive optical design in the visible and the infrared wavelengths. The functions are produced by using Equation 3 to find the instantaneous change in refractive index for a given material.

The relative partial dispersion characteristics of a material in its non-linear form may provide information regarding the interaction of materials as they transition from one region of the electromagnetic spectrum to another. The instantaneous changes to the dispersion of materials can be determined using the following Equation 4, which applies the same mathematical treatment to the function in Equation 3:

$${δ}^{″} ( {λ}_{n} ) := \frac{Δ {δ}^{′} ( λ}{Δλ} \qquad ( 4 )$$

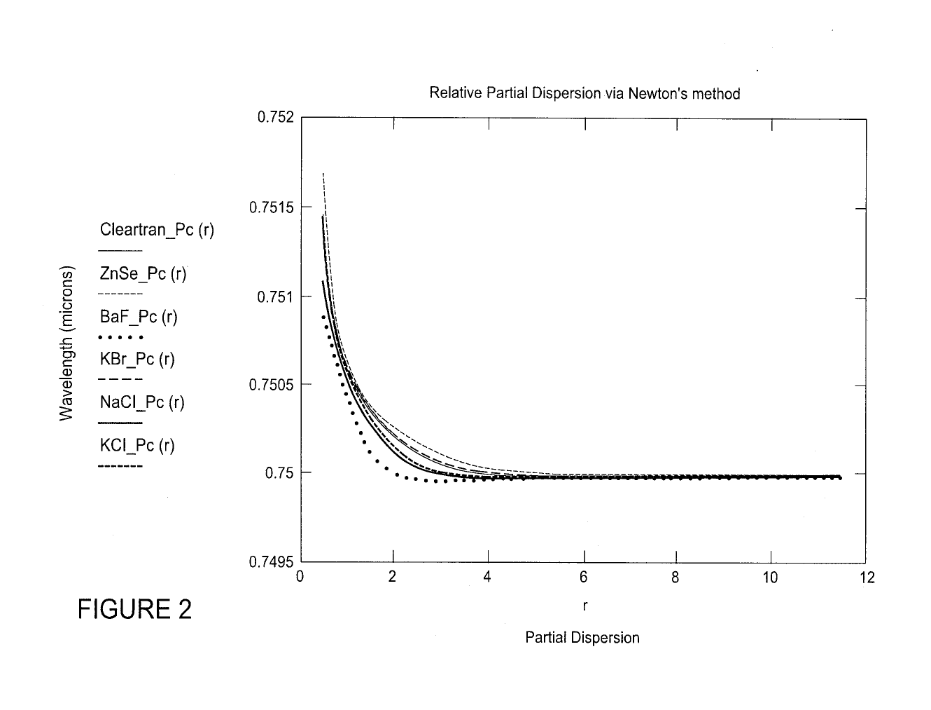

FIG. 2 shows the partial dispersive behavior of the same optical materials shown in FIG. 1, which are suitable for transmissive optical design in the visible and the infrared wavelength.

The present lens systems comprise various arrangements of lenses formed from various optical crystal materials (“optical crystals”) which enable the lens to image an object in the visible, the short wave infrared and the far infrared regions of the electromagnetic spectrum, separately or in combination.

Suitable optical crystals from which the lenses used in the present lens systems include, but are not limited to, zinc sulfide (“ZnS”), zinc selenide (“ZnSe”), potassium bromide (“KBr”), and the like. One suitable material for the ZnS lens is available under the product name Cleartran®.

Suitable lens systems according to the present disclosure comprise at least a pair of lenses comprising two different optical crystals with substantially similar optical dispersion and partial dispersion behavior throughout the VIS-IR region; with the largest possible difference in optical dispersion values; and with the least difference in partial dispersion values. As a result, the present lens systems are capable of delivering superior imaging over the spectral range of visible to far infrared wavelengths.

The foregoing materials are suitable for diamond turning and are therefore capable of aspheric deformation, which provides greater control over optical aberrations. It is desirable for the optical crystal materials used in the present lens systems to be amenable to aspheric deformation using various optical fabrication methods, such as single point diamond turning, because aspherical lens systems have a greater degree of aberration correction potential than non-aspherical forms, resulting in the use of a minimal number of optical elements.

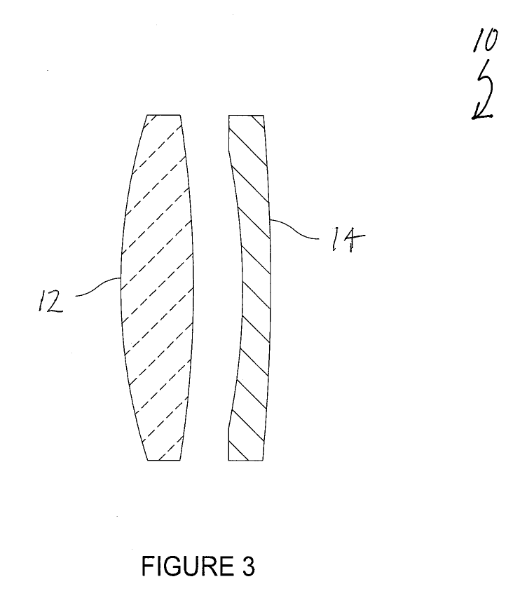

FIGS. 3 and 5-8 shows a variety of exemplary lens systems according to the present disclosure, each of which is designed to provide superior imaging throughout the VIS-IR region. The lens system are capable of simultaneously imaging over the spectral range of visible to far infrared radiation, and provide color correction in either the visible, short wave infrared, longwave infrared or simultaneously in both the visible, short wave infrared and the far infrared regions of the electromagnetic spectrum, making them suitable for multi or dual band imaging applications.

FIG. 3 shows an exemplary air-spaced lens doublet 10 according to the present disclosure. The lens doublet 10 is scaled for an effective focal length of 100 millimeters (“mm”) at a wavelength of 1.0 μm and a relative aperture of f/5. As shown, the lens doublet comprises a positive lens element 12 comprising KBr and a negative lens element 14 comprising ZnS. The design form of the lens doublet 10 is specified in the following Table A. In Table A, and in all tables herein, the lens element surfaces are numbered consecutively from left to right in accordance with conventional optical design practice. In Table A, the “radius” listed for each surface is the radius of curvature of the surface at the relative aperture of f/5. In addition, in accordance with convention, the radius of curvature of an optical surface is said to be positive if the center of curvature of the surface lies to the right of the surface, and negative if the center of curvature of the surface lies to the left of the surface. The “thickness” listed for a particular surface is the thickness of the lens element bounded on the left by the indicated surface, where the thickness is measured along the optical axis of the system. The “material” listed for each surface refers to the type of optical material used for making the lens element bounded on the left by the indicated surface.

TABLE A

| Surface | Radius | Thickness | |
|---|---|---|---|
| No. | (mm) | (mm) | Material |
| 1 | 44.8 | 8.0 | KBr |
| 2 | −57.8 | 1.0 | air |
| 3 | −58.4 | 4.0 | ZnS (Cleartran) |
| 4 | −126.8 | 91.9 | air |

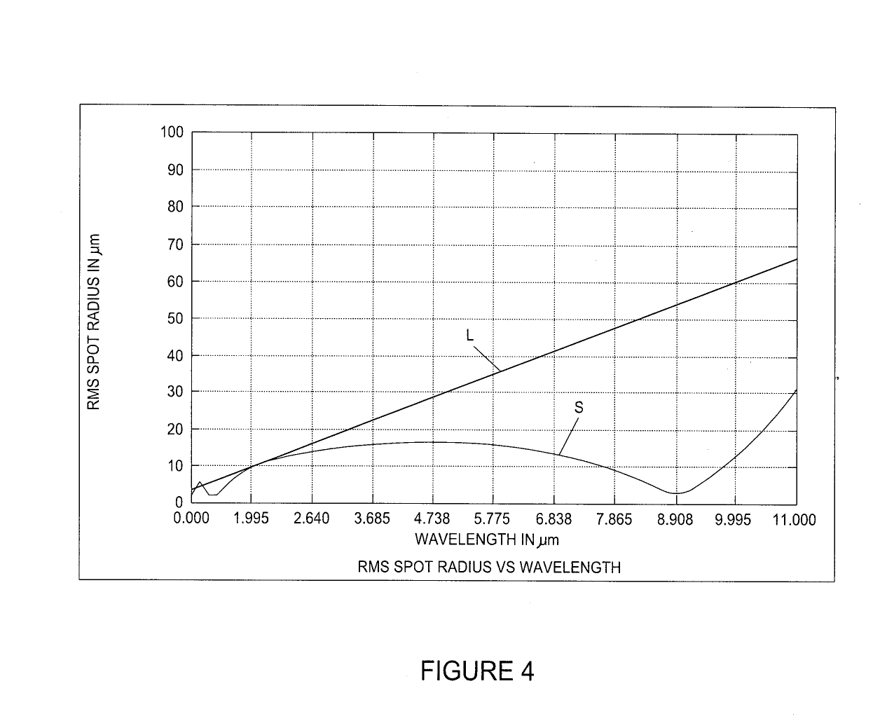

FIG. 4 depicts and indicates the variation of root mean square (“RMS”) spot radius (a measure of image blur size and therefore inversely proportional to the ability of the lens to resolve finer detail) with respect to a particular wavelength extending from about 0.55 μm to about 11 μm throughout the visible to the far infrared portion of the electromagnetic spectrum and located at the focal plane of the doublet. Color correction at the focal surface of the doublet is considered diffraction limited and, therefore, of the highest quality for those wavelengths at which RMS spot radius S has a value less than that designated by the diffraction limit indicated by L in the figure.

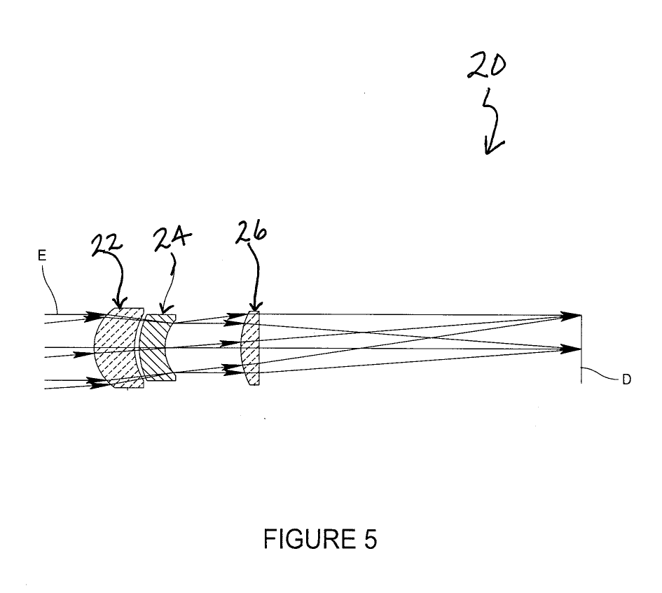

FIG. 5 shows a side view of triplet lens system 20, according to the present disclosure. As shown, lens system 20 comprises a three element lens with a focal length of 100 mm at a wavelength of 1.0 μm, and a relative aperture of f/5. Lens system 20 comprises a positive lens element 22 comprising KBr, a negative lens element 24 comprising ZnS, and a third positively powered lens element 26 comprising KBr. The lens system is corrected for electromagnetic energy E of wavelengths ranging from 0.55 μm to 11.0 μm. The design form of the present exemplary lens 20 is specified below in Table B:

TABLE B

| Surface | Radius | Thickness | |
|---|---|---|---|
| No. | (mm) | (mm) | Aspheric Deformation |
| OBJ | Infinity | Infinity | |
| 1 | 32.07 | 12.0 | KBr |
| 2 | −1682 | 1.00 | |
| 3 | 82.13 | 9.00 | ZnS (Cleartran) k = 0.0 |
| | | | i. A1 = 0 |
| | | | ii. A2 = −2.21033E−006 |
| | | | iii. A3 = 0 |
| | | | iv. A4 = 0 |
| 4 | | 20.00 | |
| 5 | −646 | 6.00 | KBr |
| 6 | −56.05 | 62.02 | |

The “Aspheric Deformation” listed for surface 1 refers to the deformation of the lens element bounded on the left by the indicated surface and described by the following aspheric equation:

$$z ( r ) := \frac{c \cdot {r}^{2}}{1 + \sqrt{1 + ( 1 - k ) \cdot ( {c}^{2} ) \cdot {r}^{2}}} + A 1 \cdot {r}^{2} + A 2 \cdot {r}^{4} + A 3 \cdot {r}^{6} + A 4 \cdot {r}^{8} + … + An \cdot {r}^{2 \cdot n} \qquad ( 3 )$$

where r is the radial height of a point on the surface, c is the surfaces base curvature described as 1/(radius of curvature), k is the surfaces conic constant and A1 . . . An designate the coefficients of deviation from a simple conic surface.

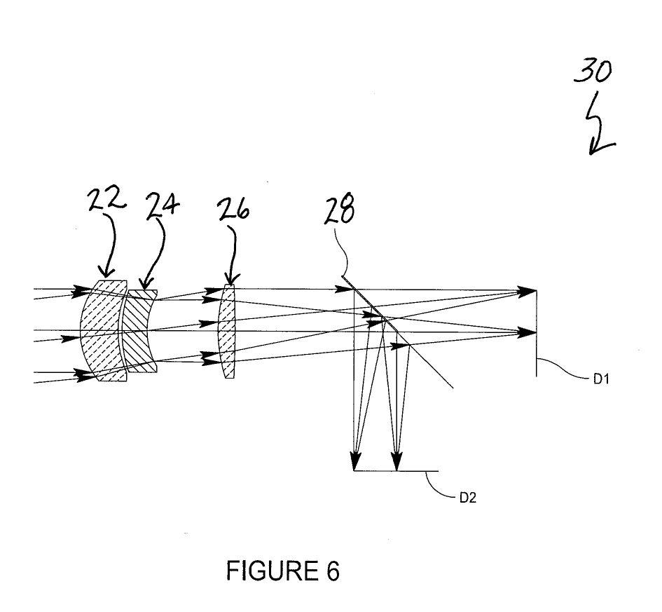

FIG. 6 shows another exemplary triplet lens system 30 according to the present disclosure, which has the same lenses as shown in lens system 20. Lens system 30 also includes a beam splitting mechanism 28 to allow energy from the one optical design to transition to two separate detectors, D1 and D2, suitable for imaging over different regions of spectral radiation.

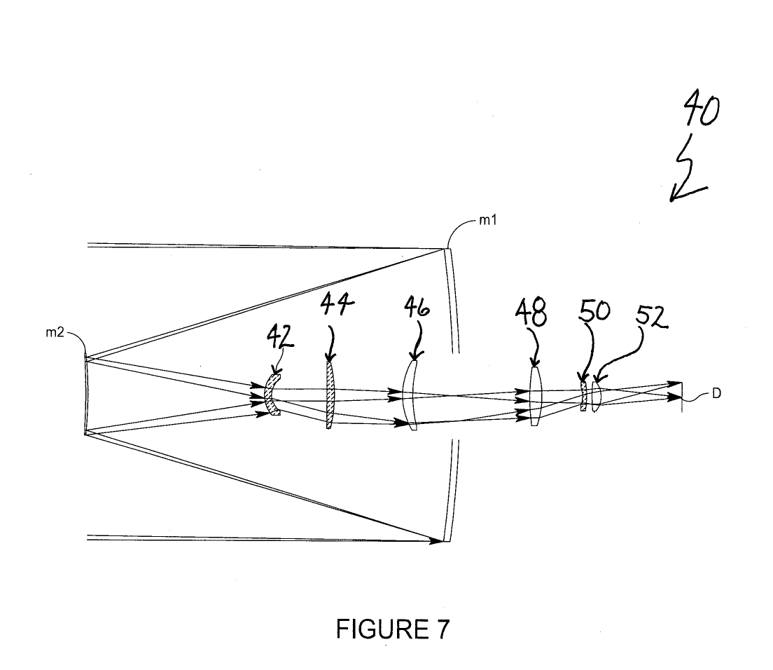

FIG. 7 shows a side view of an exemplary catadioptric objective lens 40 comprising focal length of 1 meter (“m”) at a wavelength of 1.0 μm and a relative aperture of f/5. “Catadioptric,” as used herein, means a lens with a combination of reflective and refractive elements. The present lens system 40 comprises a set of powered mirrors comprising a front telescope set, m1 and m2, followed by a negative ZnS (Cleartran) lens element 42 with aspheric deformation, followed by a positive Cleartran element 44. Two positive lens element made of KBr 46 and 48, and a third negatively powered Cleartran element with an aspheric deformation 50 followed by a final positive lens element made of potassium bromide crystal 52 which is corrected for electromagnetic energy E of wavelengths ranging from 0.55 to 11.0 microns.

The design form of the lens system 40 is shown below in Table C:

TABLE C

| Surface | Radius | Thickness | | Aspheric |
|---|---|---|---|---|
| No. | (mm) | (mm) | Material | Deformation |
| 1 | Infinity | Infinity | | |
| 2 | −837.0 | −312.62 | Mirror | K: −0.017 |
| 3 | −399.3 | 184.0 | Mirror | K: 21.8 |
| 4 | 21.0 | 5.00 | ZnS (Cleartran) | |
| 5 | 12.35 | 37.7 | i. A1 = 0 | K: −0.413 |
| | | | ii. A2 = −4.006875e−006 | |
| | | | A3 = −2.703303e−008 | |
| 6 | Infinity | 5.00 | ZnS (Cleartran) | |
| 7 | −102.75 | 61.70 | | |
| 8 | 47.72 | 7.00 | KBr | |
| 9 | 100.93 | 15.06 | | |
| 10 | Infinity | 67.34 | KBr | |
| 11 | 158.78 | 8.0 | | |
| 12 | −66.4 | 41.4 | Cleartran | |
| 13 | −27.34 | 3.0 | | k: 5.969 |
| 12 | −52.43 | 3.8 | KBr | |
| 13 | 210.21 | 6.0 | | |
| 14 | −15.68 | 55.4 | | |
| | IMA | Infinity | | |

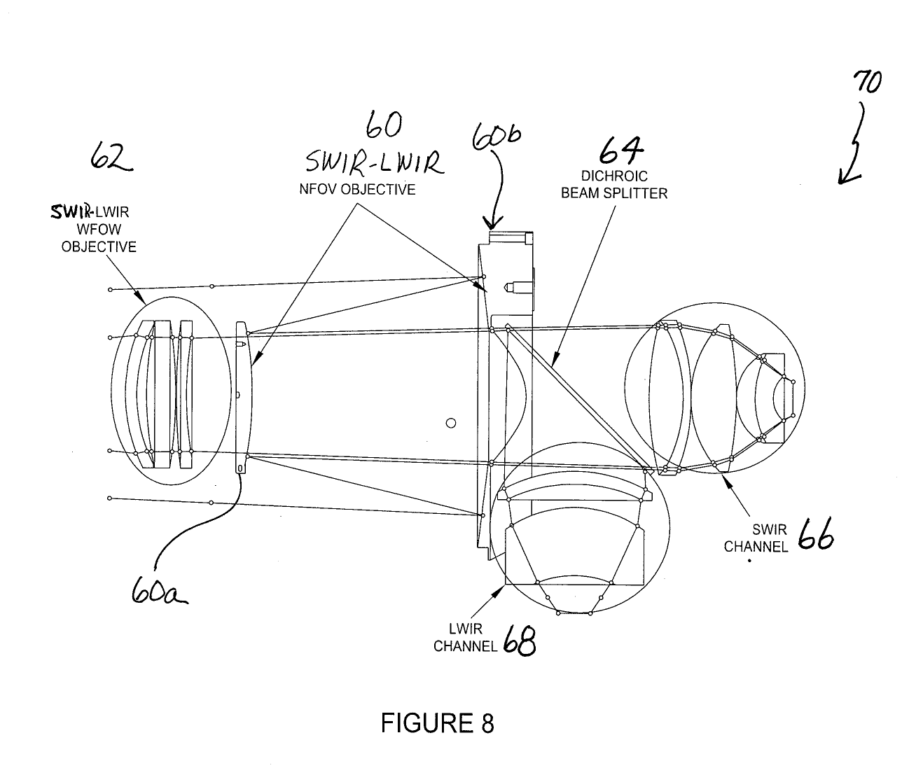

FIG. 8 shows a side view of another exemplary SWIR-LWIR catadioptric objective lens 70 that is capable of switching between a narrow field of view with a focal length of 200 mm, and a wide field of view with a focal length of 100 mm, at a wavelength of 1.0 μm and a relative aperture of f/2.4.

Lens system 70 comprises a set of powered mirrors comprising a narrow field of view reflective set 60 (comprising 60a and 60b) for narrow field of view and an alternate wide field of view objective triplet 62 comprised of ZnSe/KBr/ZnS (Cleartran). A dichroic beam splitter 64 may be used to divert the energy into either a SWIR channel 66 or to the long wave infrared (LWIR) channel 68. Operation of lens system 70 in narrow field mode is illustrated in FIG. 8. As shown, light enters from the left, hits minor 60b, bounces off folding minor 60a, and then goes on to be split by beam splitter 64 between LWIR channel 68 and SWIR channel 66. In operation, in wide field mode, folding minor 60a is removed (not illustrated), light enters from the left, and then goes through the wide field of view triplet objective 62 and then goes on to be split by beam splitter 64 between LWIR channel 68 and SWIR channel 66. The design form of the lens system 60 is shown below in Tables D, and in switched format in Table E:

TABLE D

| Surface | Radius | Thickness | | Aspheric |
|---|---|---|---|---|
| No. | (mm) | (mm) | Lens Material | Deformation |
| OBJ | Infinity | Infinity | | |
| 1 | Infinity | 9.979 | | |
| 4 | 102.071 | 7.000 | ZnSe | |
| 5 | 94.148 | 6.605 | | k: 0.02482679 |
| 6 | 222.456 | 18.000 | KBr | |
| 7 | −336.492 | 0.800 | | |
| 8 | 471.319 | 6.500 | ZnS (Cleartran) | |
| 9 | 286.731 | 190.978 | | |
| 10 | Infinity | 99.000 | | |
| 11 | 162.169 | 21.000 | BaF₂ (crystal) | |
| 12 | −91.847 | 5.000 | Ohara Flint Glass (S- | |
| | | | NPH1) | |
| 13 | −135.988 | 0.100 | | |
| 14 | 71.194 | 28.000 | Ohara Crown Glass | |
| | | | (FPL51) | |
| 15 | −237.326 | 0.100 | | |
| 16 | 30.315 | 12.000 | BaF₂(crystal) | k: −0.2333154 |
| 17 | 58.934 | 10.996 | Ohara Flint Glass (S- | |
| | | | NPH1) | |
| 18 | 19.070 | 12.000 | | |
| IMA | Infinity | | | |

TABLE E

| Surface | Radius | Thickness | | Aspheric |
|---|---|---|---|---|
| No. | (mm) | (mm) | Glass | Deformation |
| OBJ | Infinity | Infinity | | |
| 1 | Infinity | 80.160 | | |
| STO | −525.418 | −150.377 | MIRROR | k −0.5212485 |
| 3 | −289.745 | 150.377 | MIRROR(switch) | k: 1.679292 |
| 10 | Infinity | 99.000 | | |
| 11 | 104.189 | 8.000 | Germanium | k: 0.6419903 |
| 12 | 97.870 | 10.000 | | |
| 13 | Infinity | 0.100 | | |
| 14 | Infinity | 4.390 | | |
| 15 | 73.119 | 42.821 | Germanium | k: 0.6367488 |
| 16 | 62.397 | 13.784 | | |
| 17 | Infinity | 0.100 | | |
| 18 | Infinity | 10.000 | | |
| IMA | Infinity | | | |

The system illustrated in FIG. 8 is operative in the SWIR-LWIR spectrum. The lens system 70 is advantageous because the system is not comprised of all mirrors, which costly, and which limit the size of the lens system.

Each of the lens systems disclosed above provide high quality, color corrected images throughout the VIS-IR region or portions thereof (i.e., the SWIR-LWIR catadioptric lens system of FIG. 8). However, the present disclosure is not limited to the foregoing lens systems, and alternate forms utilizing the forgoing methodology are within the scope of the disclosure. For example, additional lens design forms of differing focal length, field of view or any application specific parameter utilizing this disclosure may be made. In addition, an alternate achromatic solution that utilizes a low powered third material combined with the primary zinc sulfide/potassium bromide pairing, to further reduce residual chromatic aberrations, may be made.

Similarly, the present disclosure is not limited to the foregoing lens materials. For example, potassium or bromide based materials with similar dispersive behavior to that of the materials in the embodiments discussed may be substituted. Similarly, zinc or sulfide based materials with similar dispersive behavior to that of the materials in the foregoing embodiment of the disclosure may be substituted.

The present lens designs and method of manufacture provide one or more of the following advantages: 1) the lens may be manufactured using materials that are not rare in nature or availability and are therefore abundant for lens production; 2) the lenses are capable of simultaneously imaging over the spectral range of visible to far infrared radiation; 3) the lenses are manufactured using crystalline materials that can be formed into aspheric shapes; 4) the lens provides a high quality image with a lower overall element count in comparison to lens designs comprised of all spherical elements, which translates to smaller, lighter packages with lower energy transmission loss; 5) the present lenses provides color correction in either the visible, short wave infrared, longwave infrared or simultaneously in both the visible, short wave infrared and the far infrared regions of the electromagnetic spectrum, making it suitable for multi or dual band imaging applications; 6) the present lens systems can feed more than one detector, thereby allowing the construction of systems that are more compact and lighter in comparison to other systems, which enables the inclusion of multispectral imaging in applications with limited space constraints; and 7) the method of selecting the optical materials comprising the lenses ensures that the materials are capable of imaging over the spectral range of visible to far infrared radiation.

It should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Similarly, it is noted that the terms “bottom” and “top” are used herein, unless otherwise noted, merely for convenience of description, and are not limited to any one position or spatial orientation. In addition, the modifier “about” used in connection with a quantity is inclusive of the stated value and has the meaning dictated by the context (e.g., includes the degree of error associated with measurement of the particular quantity).

Compounds are described herein using standard nomenclature. For example, any position not substituted by an indicated group is understood to have its valency filled by a bond as indicated, or a hydrogen atom A dash (“-”) that is not between two letters or symbols is used to indicate a point of attachment for a substituent. For example, —CHO is attached through the carbon of the carbonyl group. Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). The notation “+/−10% means that the indicated measurement may be from an amount that is minus 10% to an amount that is plus 10% of the stated value.

Finally, unless defined otherwise, technical and scientific terms used herein have the same meaning as is commonly understood by one of skill in the art to which this disclosure belongs.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. For example, optical crystals with similar dispersive and partial dispersive behaviors to that of the optical crystals in the disclosed embodiments could be substituted. Additional lens design forms of differing focal length, field of view or any application specific parameter utilizing this disclosure could be realized by practitioners in the art of optical design. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A lens system capable of imaging in the visible and infrared spectral regions, comprising:
a first, positive lens comprising a first optical crystal material; and
a second, negative lens adjacent to the first lens, the second lens comprising a second optical crystal material, different than the first optical crystal material;
wherein the lens system is operative for imaging in a spectral region with wavelengths ranging from about 0.5 microns (μm) to about 12.0 μm.

2. The lens system of claim 1, wherein the second lens comprises potassium bromide.

3. The lens system of claim 2, wherein the first lens is zinc sulfide or zinc selenide.

4. The lens system of claim 1, further comprising a third lens adjacent to the second lens, opposite the first lens, wherein the third lens is potassium bromide, zinc sulfide or zinc selenide.

5. A lens system, comprising:
a first, positive lens comprising a first optical crystal material; and
a second, negative lens adjacent to the first lens, the second lens comprising a second optical crystal material, different than the first optical crystal material;
a third lens adjacent to the second lens, opposite the first lens, the third lens being selected from the group consisting of potassium bromide, zinc sulfide and zinc selenide;
wherein the lens system is operative for imaging in a spectral region with wavelengths ranging from about 0.5 microns (μm) to about 12.0 μm.

6. A lens system, comprising:
a first lens comprising potassium bromide; and
a second lens adjacent to the first lens, the second lens comprising zinc sulfide;
wherein the lens system is operative for imaging in a spectral region with wavelengths ranging from about 0.5 microns (μm) to about 12.0 μm.
